(19) United States
(12) Patent Application Publication
(10) Pub. No.: US 2021/0086857 A1
(43) Pub. Date: Mar. 25, 2021

(54) BALANCE BIKE WITH FUNCTION OF KICK SCOOTER

(71) Applicant: YEN-HO LU, Taichung (TW)

(72) Inventor: YEN-HO LU, Taichung (TW)

(21) Appl. No.: 16/576,771

(22) Filed: Sep. 20, 2019

(51) Int. Cl. B62K 3/00; B62K 13/00; B62J 1/08

(52) U.S. Cl. CPC B62K 3/002; B62J 1/08; B62K 13/00

(57) ABSTRACT

This invention is a balance bike with function of kick scooter with adjustable seat height in balance bike mode. It mainly comprises a weight holding device, a steering unit that connects to a main unit, which connects to a rear wheel unit. The steering unit mainly comprises a steering bar, a steering tube, and front wheel(s). The main unit mainly comprises a seatstay and a seat body. When the invention is viewed in balance bike mode, the weight holding device is employed to connect the seat body to the steering unit to hold the weight of users, the upper portion of the seatstay is connected to the seat body, and in the seat body there is a seat portion whose rear end is higher than its front end.

### BACKGROUND OF INVENTION

### 1. Field of Invention

The present invention relates to a balance bike that can transform into a kick scooter, particularly to a mechanism that enables multiple sitting positions in balance bike mode.

### 2. Related Prior Art

One of prior arts is that its seat is directly connected to the steering unit, and thus the seat can not be extended too far away from the steering unit due to torque limitation, making it not suitable for elder kids. The other of prior arts is convenient in transforming between balance bike and kick scooter, however, the height of its seat can't be adjusted for different heights due to its streamline design.

### SUMMARY OF INVENTION

Balance bike and kick scooter are popular sports gears among kids. Parents always buy the two items for their little kids. This invention is proposed to combine both functions into one with adjustable seat heights in balance bike mode, so that it can be used with more funs for some many years. The invention, a balance bike with function of kick scooter, mainly comprises a weight holding device, a steering unit that connects to a main unit, which connects to a rear wheel unit. Like prior arts, the steering unit mainly comprises a steering bar, a steering tube, and front wheel. The main unit mainly comprises a seatstay, and a seat body.

The main features of this invention are that firstly, upper portion of the seatstay is connected to the seat body when in balance bike mode; secondly, most area (say over 60%) of at least one of top and bottom faces of the seatstay is flat-like (“flat-like” here means looking like flat in far/macro or side view. The surface, in close/micro view, may still have small studs for grip purpose or some non-flat conditions such as pattern of groove for aesthetic purpose.), so for users to easily and comfortably stand on when the invention in kick scooter mode; thirdly, the weight holding device (ex: a stopper, a buckle or recess) is employed to connect the seat body to the steering unit to hold the weight of users when in balance bike mode, so users can sit in adequate and stable condition; fourthly, in the seat body there is a seat portion, which is the part that helps facilitate multiple sitting positions with its rear end apparently higher than its front end when viewed in balance bike mode, so that the more rear a sitting position is from the steering unit, the higher it is, meeting ergonomics.

### BRIEF DESCRIPTION OF DRAWINGS

The present invention will be described via detailed illustration of the embodiment, and drawings wherein:

FIG. 1 is a perspective view of the first embodiment in balance bike mode;

FIG. 2 is a cross-sectional view of the first embodiment in balance bike mode;

FIG. 3 is a side view of the first embodiment in kick scooter mode;

FIG. 4 is a side view of the second embodiment in balance bike mode;

FIG. 5 is a side view of the second embodiment in kick scooter mode;

FIG. 6 is a perspective view of the buckling device as the weight holding device;

FIG. 7 is a side view of the first embodiment with the buckling device;

FIG. 8 is a side view of the third embodiment in balance bike mode;

FIG. 9 is a side view of the third embodiment in kick scooter mode;

FIG. 10 is a cross-sectional view of the foldable footrest;

FIG. 11 is a bottom view of an alternative rear wheel unit when in combined one-wheel state; and

FIG. 12 is a bottom view of an alternative rear wheel unit when in two-separate-wheel state;

### DETAILED DESCRIPTION OF PREFERRED EMBODIMENT

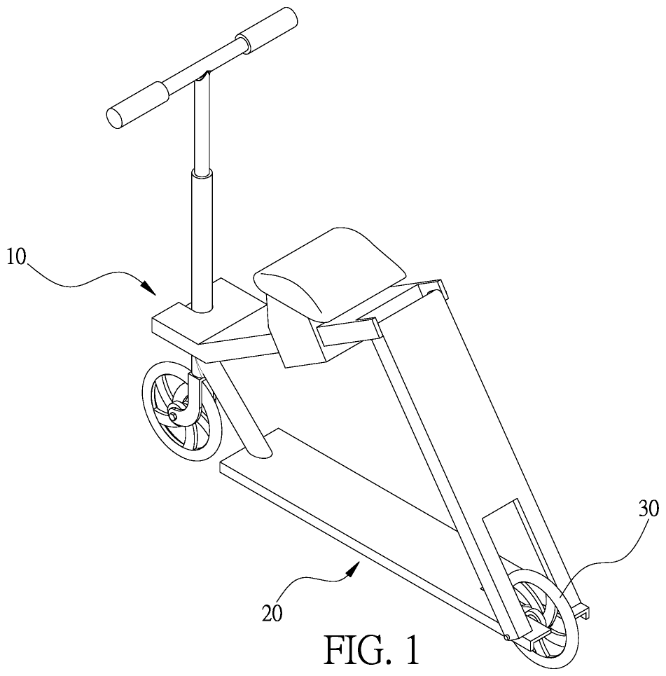

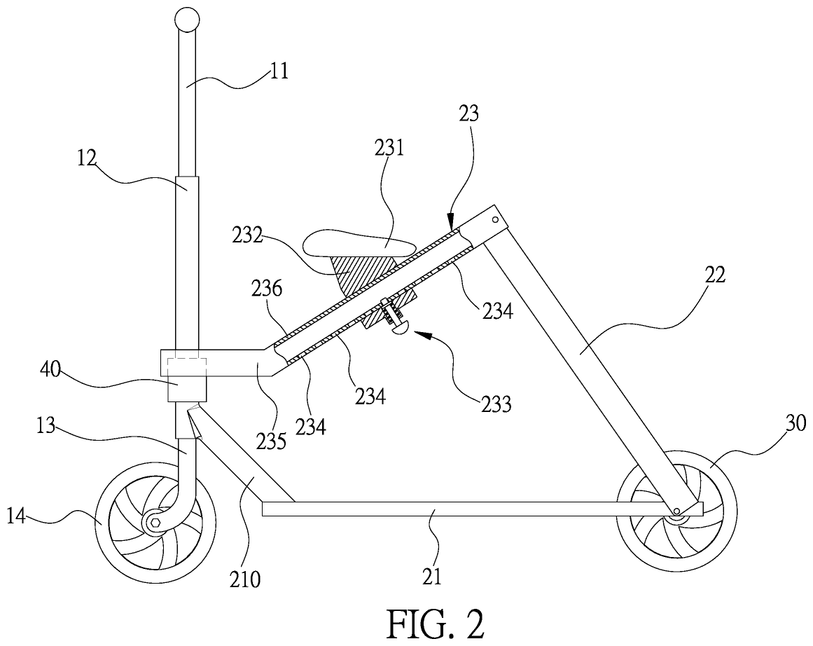

The first embodiment, referring to FIGS. 1, 2 and 3, comprises a weight holder 40 as a weight holding device, a steering unit 10 that connects, by a connector 210 (or can be direct connection without the connector 210), to a main unit 20, which directly connects to a rear wheel unit 30 (the rear wheel unit 30 can mean one or two wheels in setting; in the figures one rear wheel setting is shown for illustration.)

The steering unit 10 comprises a steering bar 11 that is inserted into a steering tube 12, and connected to a fork 13 (or the fork structure can be directly facilitated at the bottom end of the steering bar 11) that connects to front wheel(s) 14.

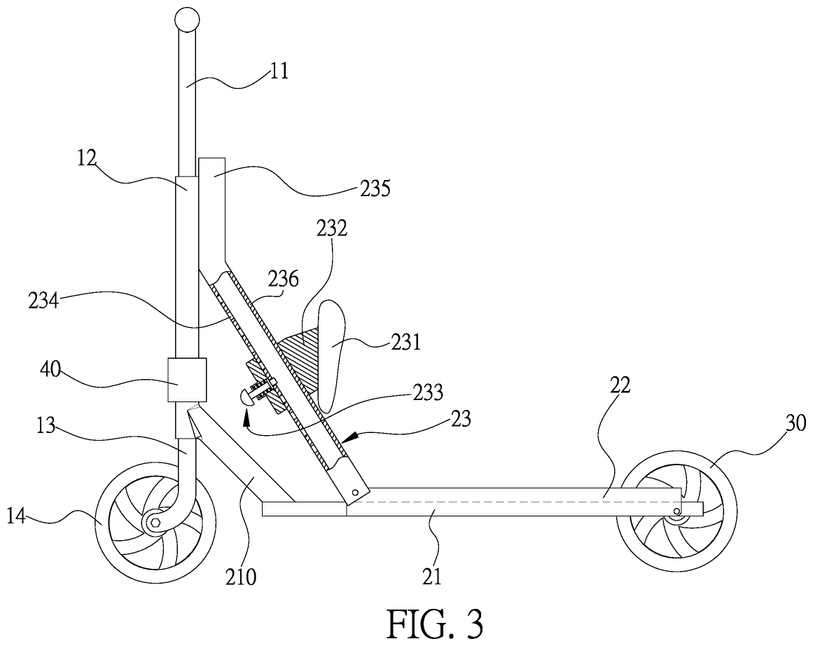

The main unit 20 comprises a base 21 whose rear end directly connects with the rear wheel unit 30, a connector 210, a seatstay 22, a seat body 23, a saddle 231 that connects to a saddle tube 232, a spring pin 233, and multiple positioning holes 234 on the seat body 23. Viewed in balance bike mode, the upper side of the seatstay 22 is pivotally connected to the seat body 23, and the lower side is pivotally connected to the rear end of the base 21. (The connecting location of the seatstay 22 and the base 21 is preferably located at the rear ⅖ part of the base 21, so that the seatstay 22 can be facilitated longer in length in real practice to raise up the seat body 23 to a higher position for taller users.) In balance bike mode, the hollow-shaped front end of the seat body 23 houses onto the weight holder 40 situated on the steering tube 12 of steering unit 10 so to connect the seat body 23 to the steering unit 10 to form structural stabilization. There is a bend 235 in front of the seat body 23 to facilitate a lower threshold for users to conveniently use the balance bike mode. The part, behind the bend 235, of the seat body 23 is the seat portion 236. The saddle tube 232 can slide against the seat portion 236, with the cooperation of the spring pin 233 and the positioning holes 234, so for enabling users to adjust the saddle 231 in various desired height positions. Referring to the FIG. 3, the seatstay 22 can collapse onto the base 21, transforming into a kick scooter. Most area of the top face of the seatstay 22 is flat for users to easily and comfortably stand on when in kick scooter mode.

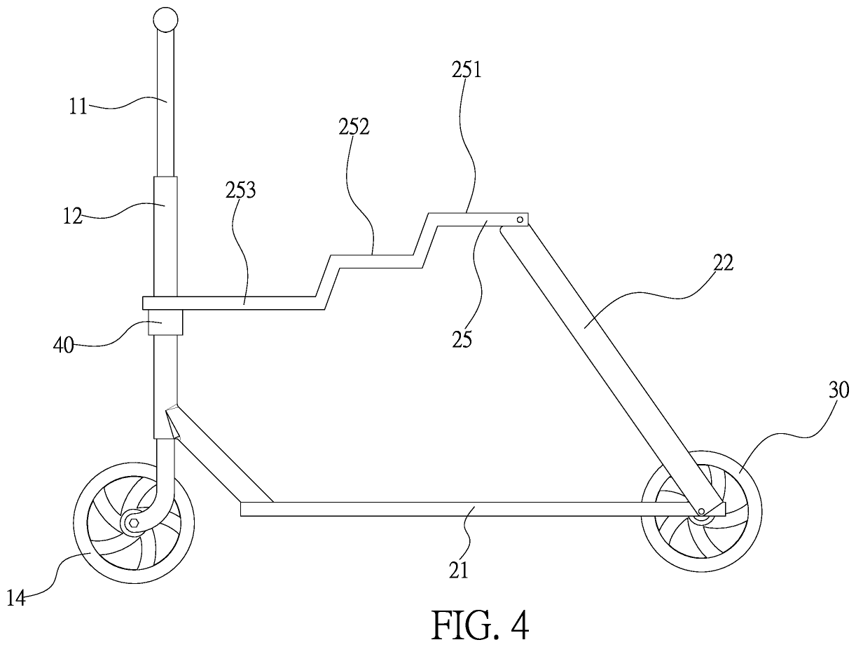

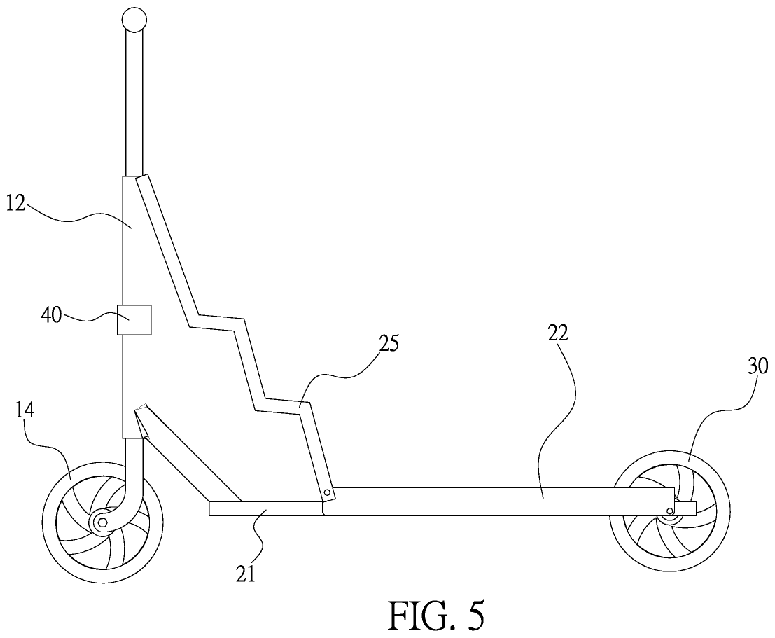

More, please refer to the FIGS. 4 and 5 for the second embodiment. The seat body 23 can alternatively just be a stair-shaped multiple-seat seat body 25 that comprises multiple sitting positions such as first sitting position 251, second sitting position 252, and third sitting position 253, and so on.

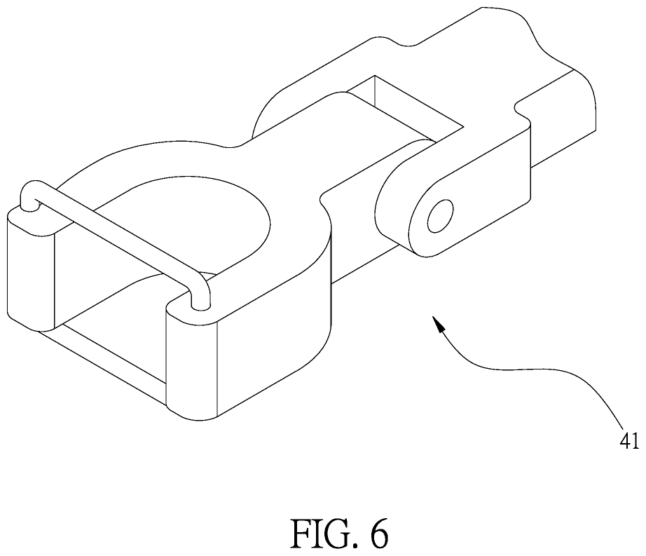

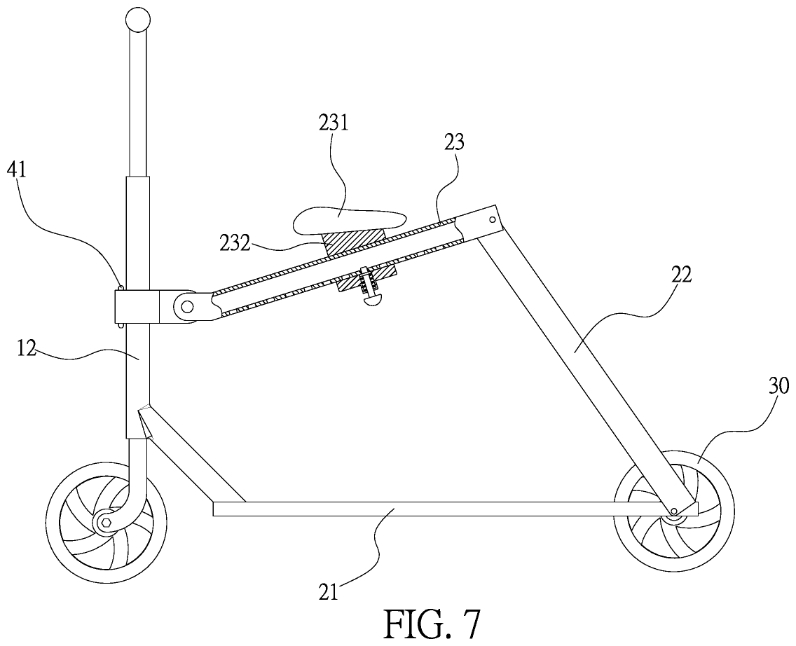

Further referring to the FIG. 6 and 7, in the aforementioned two embodiments, the weight holder 40 can alternatively be a buckling device 41 situated in the front end of the seat body 23, and it connects the seat body 23 to the steering tube 12.

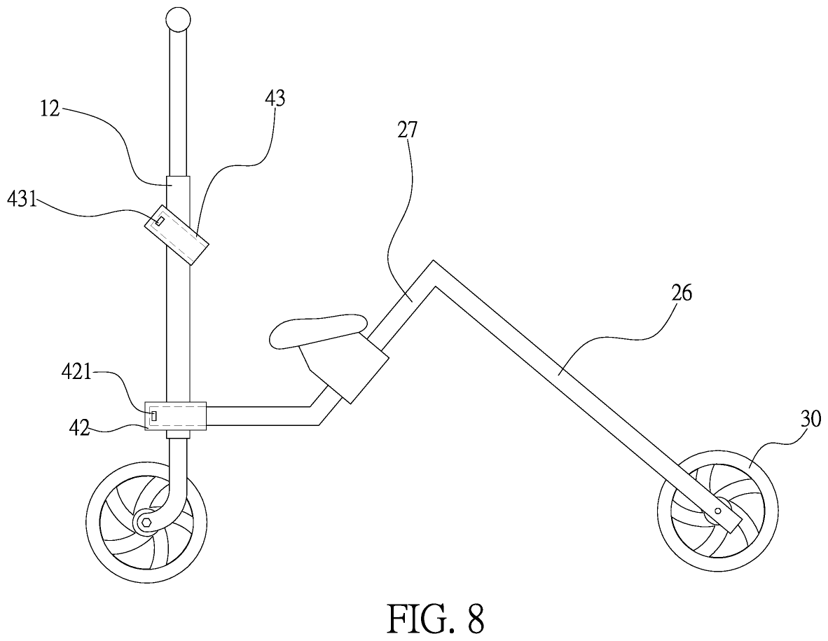

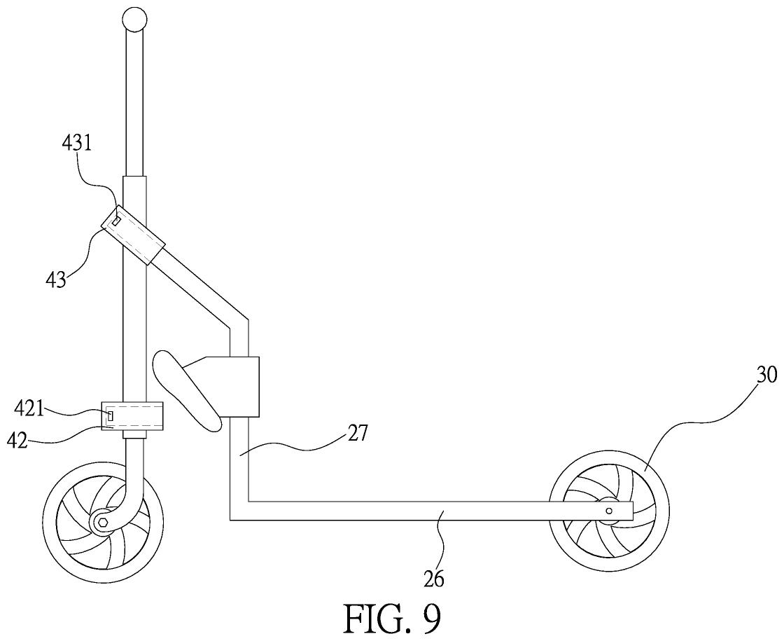

Moreover, please refer to FIG. 8 and 9 for the third embodiment of the invention. In this embodiment, the main differences from abovementioned embodiments are: there is no base, the seatstay 26 and seat body 27 are so connected as one piece, and there are a weight holding recess 42 as the weight holding device and a positioning device 43 on the steering unit 10. There are holding holes 421 on both sides of the weight holding recess 42, and positioning devices 431 on both sides of the positioning tube 43. When in balance bike mode, the front end of the seat body 27 is inserted into, and engages with the weight holding recess 42 by its pins (common in existing practices, thus not shown in figures). When in kick scooter mode, the front end of the seat body 27 is reversely inserted into, and engages with the positioning device 43 by its pins. Most area of the bottom face (viewed in balance bike mode) of the seatstay 26 is flat-like so for users to stand on comfortably when transformed into kick scooter mode.

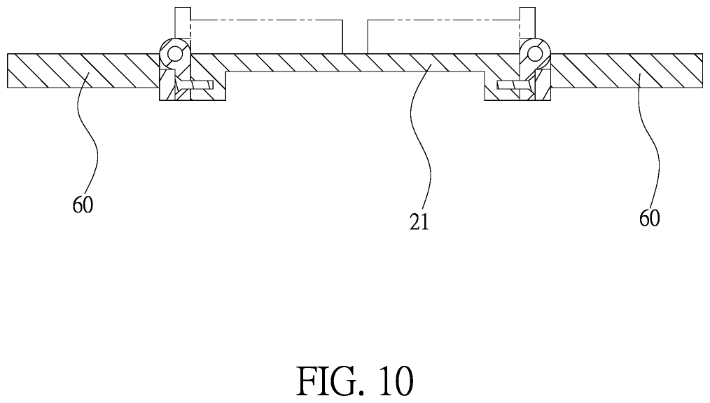

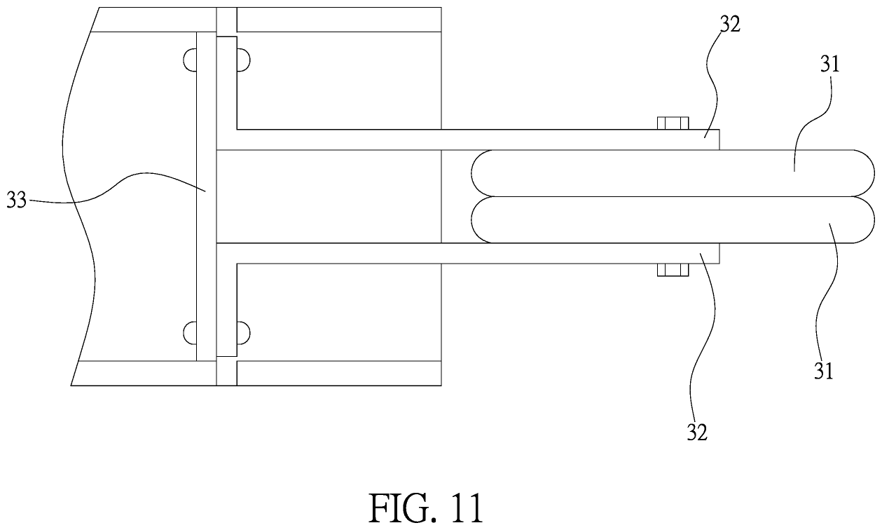

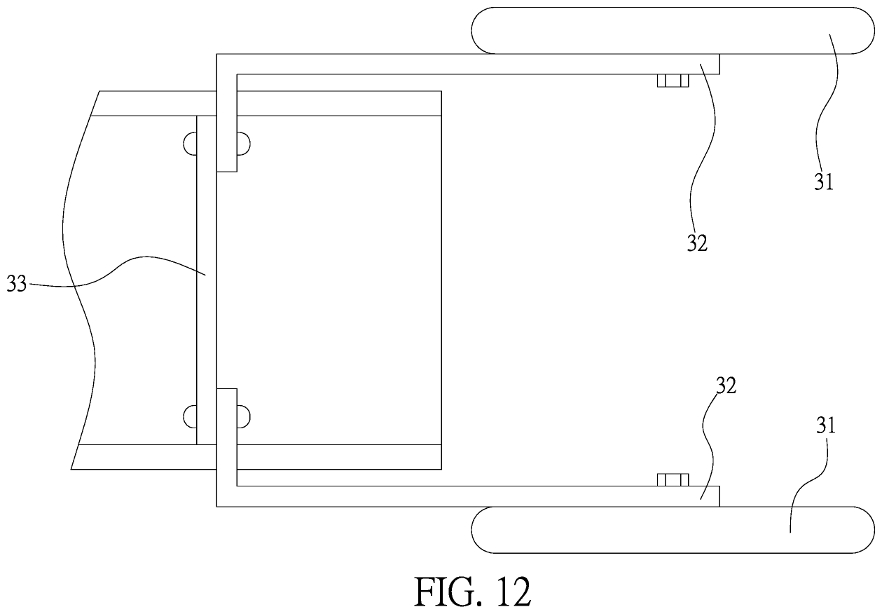

Further for aforementioned embodiments, a pair of foldable footrest 60 can be facilitated either on the steering unit 10 or at front of the main unit 20 as shown in FIG. 10. Furthermore, as shown in FIG. 11 and 12, the rear wheel unit 30 can further comprise two rear wheels 31, two L-shaped connectors 32 and a bridge 33, wherein the bridge 33 is connected to the bottom of the base 21 across its two long sides, and the two L-shaped connectors 32 are pivotally connected to the bridge 33 at proper location in one end and connected to the rear wheels 31 in the other end respectively. The rear wheel unit 30 appears as one combined rear wheel state when the L-shaped connectors 32 rotated inward, and it appears as two separate rear wheels state when the L-shaped connectors 32 rotated outward, providing users with options of funs and stabilities.

1. A balance bike with function of kick scooter comprising: a weight holding device, a steering unit, a main unit and a rear wheel unit; the steering unit comprising a steering bar, and front wheel(s); the main unit comprising a seatstay and a seat body; the main features are that firstly, the upper portion of the seatstay is connected to the seat body when in balance bike mode;
secondly, in the seat body there is a seat portion that helps facilitate multiple sitting positions with its rear end apparently higher than its front end when in balance bike mode.

2. The balance bike with function of kick scooter according to claim 1, wherein the weight holding device is situated on at least one of the steering unit and front end of the seat body.

3. The balance bike with function of kick scooter according to claim 1, wherein the weight holding device connects the seat body to the steering unit when in balance bike mode.

4. The balance bike with function of kick scooter according to claim 1, wherein most area of at least one of top and bottom faces of the seatstay is flat-like.

5. The balance bike with function of kick scooter according to claim 1, wherein the main unit further comprising a saddle that can be adjusted in multiple height positions on the seat body.

6. The balance bike with function of kick scooter according to claim 5, wherein the saddle is adjusted by sliding mechanism.

7. The balance bike with function of kick scooter according to claim 1, wherein the seat body comprising at least a bend in its front side.

8. The balance bike with function of kick scooter according to claim 1, than main unit further comprising a base whose rear side is connected to the lower portion of the seatstay when in balance bike mode.

9. The balance bike with function of kick scooter according to claim 8, the connecting location of the seatstay and the base is located at the rear ⅖ part of the base.

10. The balance bike with function of kick scooter according to claim 8, wherein the connection is a pivotal one.

11. The balance bike with function of kick scooter according to claim 1, wherein the seat body further comprising a first sitting position and second sitting position.

12. The balance bike with function of kick scooter according to claim 1, wherein the rear wheel unit comprising two rear wheels connecting to two L-shaped connectors respectively; the rear wheel unit appears as one combined rear wheel state when the L-shaped connectors rotated inward, and the rear wheel unit appears as two separate rear wheels state when the L-shaped connectors rotated outward.

13. The balance bike with function of kick scooter according to claim 1, further comprising a pair of footrest located at one of the steering unit and the front of the main unit.

14. The balance bike with function of kick scooter according to claim 1, wherein the front end of the seat body is hollow-shaped.

15. The balance bike with function of kick scooter according to claim 1, wherein the seatstay and the seat body are so connected as one piece.

16. The balance bike with function of kick scooter according to claim 1, further comprising a positioning device on the steering unit.

17. The balance bike with function of kick scooter according to claim 1, wherein the connection of the seatstay and the seat body is a pivotal one.
